(19) United States
(12) Patent Application Publication
(10) Pub. No.: US 2004/0088971 A1
(43) Pub. Date: May 13, 2004

(54) Unlimited power system

(76) Inventor: Avihou Mishnayot, New York, NY (US)

Correspondence Address: AVIHOU MISHNAYOT, 315 EAST 86TH ST., APT. 4 WE, NEW YORK, NY, 10028, US

(21) Appl. No.: 10/291,137

(22) Filed: Nov. 9, 2002

(51) Int. Cl. F16D 31/02

(52) U.S. Cl. 60/398

(57) ABSTRACT

A hydro electric power plant, specifically structured to operate by moving fluid, e.g. water, from a low level reservoir to a high level reservoir, and back through a turbine-generator, water wheel, etc. which is structured to be self sufficient, and to supply an unlimited amount of power.

### BACKGROUND OF THE INVENTION

The present invention generally relates to a system for efficiently providing a continuing flow of water, or other fluids, for the purpose of e.g., generating power, such as electricity, hydrodynamically, and specifically, by the flow of fluid from one reservoir, to a second reservoir, located at a higher elevation, returning down through a turbine generator wheel, etc., back to the first reservoir. There is a great need today to provide a renewal energy source of generating electricity. Investigations have tried to tap solar energy, wind energy, and the energy from flowing water. Because of the nature of this invention, there is no need for reference on past inventions.

### BRIEF DESCRIPTION OF THE DRAWINGS

The drawings presented herewith illustrates embodiment of the present invention, but are not to be taken as exclusive of the full scope of the present invention. The illustrated embodiment includes conventional means, which are shown in schematic form. More detailed illustration is deemed unnecessary because of their conventional nature.

Referring to the drawing of FIG. 1, the following is depicted: A pipe 2 is connected to the bottom of a high level reservoir 1 and extends downwardly with a fluid flow connection to outlet 3 of fluid mixer 4. The frame 6 holds the fluid mixer. No. 7 transfers high pressure water from small pipe 8 into fluid mixer 4. Pipe 9 has a fluid flow connection to pump outlet 16 extending downwardly with fluid flow connection to pipe 8. No. 10 is the holding frame for pump 11 and motor 12. No. 15 is the inlet of the pump. No. 14 is a short pipe with fluid flow connection between the bottom of the reservoir 1 and inlet of the pump 15. No. 17 is a pipe connected to the bottom of reservoir 1, extended downwardly with fluid flow connection to inlet 18 of turbo generator 20. No. 19 is the outlet of turbo generator 20. No. 21 is a short pipe connected to outlet 19 and moves the water to the low level reservoir 22. No. 23 is a pipe with fluid flow connection to the bottom of the low level reservoir 22, extended downwardly with fluid flow connection to one way valve 24. Pipe 25 connects the bottom of one way valve 24 to the inlet of fluid mixer 26.

FIG. 2 is a view of the fluid mixer. No. 30 is the inlet of low pressure water that comes from the low level reservoir. No. 31 is the outlet of the fluid mixer with fluid flow connection to the bottom of the high level reservoir. No. 27 is the body of the fluid mixer. No. 28 is a pipe, that has connection to high pressure water from the high level reservoir on one side and with a fluid flow connection to No. 29 on the other side. No.29 has a double function: (A) It moves the high pressure water from the high level reservoir into the fluid and (B) when the pump is operated, it increases the pressure of the water to the required level. No. 32 is the interior portion of the fluid mixer where the low pressure and high pressure water meet and mix.

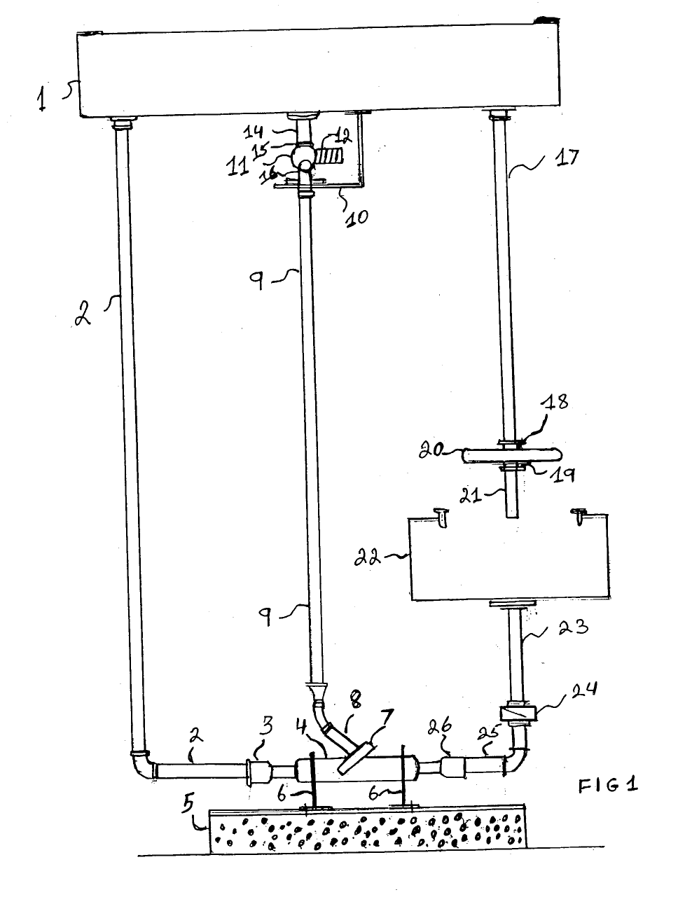

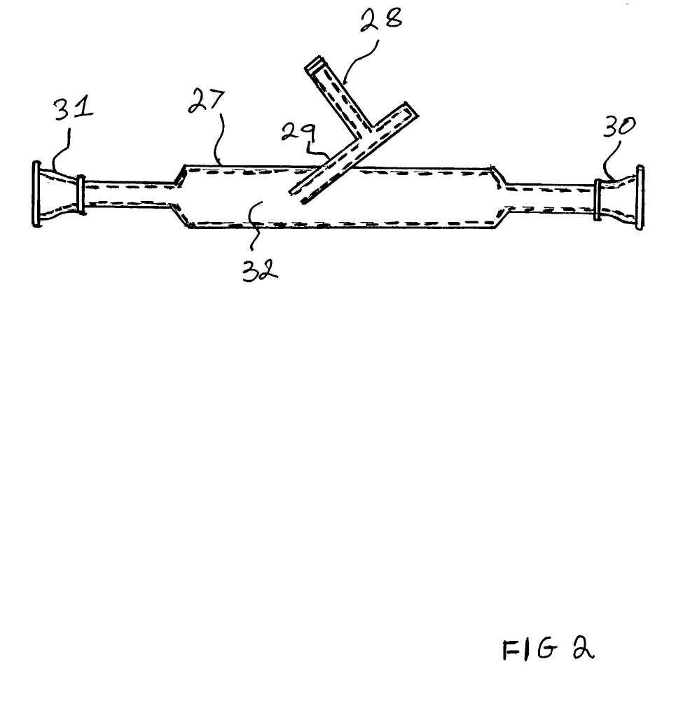

### SUMMARY OF THE PRESENT INVENTION

It is therefore an object of this invention to provide a means for generating, e.g., electricity from flowing fluid, moving from one reservoir to another reservoir and back. It is further an object of this invention to specifically generate electricity by the flow of fluid, preferably water, from one reservoir located at a low level, to a second reservoir, located at a higher elevation, returning down through a turbine generator wheel, etc., by means of gravity to the first reservoir. This and other objects of the invention are achieved by a system that includes one pump.

The pump is driven preferably by electric motor 12. The pump inlet 15 is connected via pipe 14 with fluid flow connection to the bottom of high level reservoir 1. Pipe 9 is connected to the outlet of the pump extended downwardly to the inlet 8 of the fluid mixer. The pump is located next to the high level reservoir I so as to reach maximum efficiency with regard to the pressure created by the height of the reservoir.

The low level reservoir is located at a height such that it has sufficient pressure for the water entering fluid mixer 4 via pipe 23, valve 24, pipe 25 to inlet 26. Low level reservoir 22 is preferably 40-60 feet above fluid mixer 4. Pipe 2, with a fluid flow connection to the bottom of the high level reservoir 1, extends downwardly with a connection to the outlet 3 of the fluid mixer 4.

When the system is filled with water and the pump is not in operation, the pressure at the inlet 7 of the fluid mixer and the pressure at the outlet 3 of the fluid mixer is equal because the water level in the pipes leading to those points starts at the same height. When the level of the reservoir 1 increases, the pressure at points 3 and 7 will increas also.

No. 17 is a pipe that connects reservoir I to inlet 18 of turbo generator 20. Turbo generator 20 converts falling water to electricity. Pipe 21 transports water from turbo generator 20 to low level reservoir 22.

In Operation

The system must be filled with liquid, e.g., water before the system begins to operate. When electric motor 12 starts to rotate, so does pump 11 and the pump draws water from reservoir 1 and into pipe 9, downwardly to the inlet 8 of fluid mixer 4. The water passes into No. 7. The exit passage for the water at the end of No. 7 is a narrow slide, preferably 1/16 to ⅛ of an inch. Therefore, pressure builds up in No. 7. The total pressure in No. 7 consists of the height of reservoir 1, plus the pressure provided by the pump propelling the water into the narrow passage of No. 7. The water exits No.7 along the bottom 4A of the fluid mixer and continues to inlet 3, pipe 2 and back to reservoir 1. The water coming from No.7 to 4A mixing area creates a barrier between the high pressure water from the high level reservoir 1 and the low pressure water from the low level reservoir22. The low pressure water presses into the high pressure water that is coming out from No. 7 and is dragged to the other side of the fluid mixer, to the direction of the outlet 3, to pipe 2 back to reservoir 1.

As an example, if valve 24 is closed, and the pump 11 circulates water, e.g., 20 gpm from one side of the reservoir 1 to the fluid mixer 4 and back to the reservoir 1, the motor would use, e.g., 300 watts. If valve 24 is then opened, and for example 10 gpm from reservoir 22 enters the fluid mixer 4 and travels to the reservoir 1, the system has now moved 30 gpm to the reservoir 1. However, the motor continues to use only 300 watts. The system moves 30 gpm through outlet 3 to reservoir 1 but pump 11 draws 20 gpm at all times for circulation. The additional 10 gpm comes to the system from reservoir 22 passing to pipe 17 downwardly to inlet 18 and to turbo generator 20 converting moving water to electricity. This water passes through outlet 19 to pipe 21 and back to low level reservoir 22. This process can continue indefinitely and the level of the water in the whole system stays the same. If the system moves e.g., 10 gpm from reservoir 22 to reservoir 1, and reservoir 1 is at a height of 100 feet, and the motor uses, e.g., 300 watts, then if the height of the reservoir 1 is moved to 500 feet or 1000 feet or higher, the system will still move the 10 gpm from reservoir 22 to reservoir 1 and the motor still uses only 300 watts. As the height of reservoir 1 is increased, at a certain height, generator 20 will produce more electricity than pump 11 needs to run the system. The difference between the amount of electricity the generator produces and what the system pump 11 needs for operation will increase as the height of the reservoir 1 is increased. This system can run indefinitely and produces limitless work output. Therefore, the system is super perpetual.

The patentable embodiments of the invention which are claimed are sa follows:

1. A system comprising of one motor, one pump and one fluid mixer, located relatively close to the surface of the body of the fluid, e.g., water, a low level reservoir, located close to the fluid mixer, a second reservoir located at a high level, a pump and electric motor, located close to the high level reservoir, a turbo generator, to convert moving water to electricity, a first pipe with fluid flow connection to the bottom of the high level reservoir and the outlet of the fluid mixer, a second pipe with fluid flow connection between the high level reservoir and the pump, a third pipe with fluid flow connection between the outlet of the pump and the inlet of the fluid mixer, a fourth pipe with fluid flow connection between the bottom of the high level reservoir and the inlet of the turbo generator, a fifth pipe connected to the outlet of the turbo generator extended downwardly close to the low level reservoir, a sixth pipe with fluid flow connection to the low and to the valve, a seventh pipe between the valve and the inlet of the fluid mixer.

2. The system of claim 1 wherein the fluid mixer has two inlets, one for the high pressure water including a holding area where high pressure builds prior to the water moving through a narrow passage which moves the high pressure water to the mixing area, and a second for a low pressure water.

3. The system of claim 2 wherein the pressure of the water, when the pump is not operating is equal at the inlet of the fluid mixer and the outlet of the fluid mixer.

4. The system of claim 3 wherein the pressure of the water in the holding area and the inlet of the fluid mixer is greater than in the outlet of the fluid mixer when the pump is in operation.

5. The system of claim 4 wherein water from the low level reservoir enters the fluid mixer, water from the high level reservoir enters the fluid mixer, moves to mixing area and back to the high level reservoir.

6. The system of claim 1 wherein the pump draws water from the high level reservoir downwardly to the inlet of the fluid mixer.

7. The system of claim 1 wherein the turbo generator converts water coming from the low level reservoir to the high level reservoir and into the turbo generator into electricity.

8. The system of claim 1 wherein the height of the high level reservoir will increase, but the system pump still uses the same amount of watts and delivers the same amount of water from the low level reservoir to the high level reservoir.

9. The system of claim 8 wherein the height of the high level reservoir will increase to a point that the turbo generator will produce more electricity than the pump needs to operate the system.

10. The system of claim 9 wherein the difference between the amount of electricity the generator produces and what the system pump needs for operation will increase as the height of the reservoir is increased.

11. The system of claim 10 wherein this system will run indefinitely and produce limitless work output and therefore, the system is “super perpetual.”
